(19) United States
(12) Patent Application Publication
(10) Pub. No.: US 2015/0332387 A1
(43) Pub. Date: Nov. 19, 2015

(54) SOCIAL NETWORK BASED ONLINE SHOPPING ENVIRONMENT AND METHOD AND PROCESS OF MANAGING DISCOUNT CODES

(71) Applicant: CAVIA LIMITED, Tewkesbury Gloucestershire (GB)

(72) Inventors: Adam Brian STACEY, Gloucester (GB); Hugh Hannay HOFTON, Gloucester (GB)

(73) Assignee: CAVIA LIMITED, Tewkesbury, Gloucestershire (GB)

(21) Appl. No.: 14/651,198

(22) PCT Filed: Dec. 10, 2013
(86) PCT No.: PCT/GB2013/053244

§ 371 Date: Jun. 10, 2015

(30) Foreign Application Priority Data
Dec. 11, 2012 (GB) 1222298.0

(51) Int. Cl. G06Q 30/06; G06F 3/0481; H04L 29/08; G06F 17/30

(52) U.S. Cl. CPC G06Q 30/0643; G06F 17/30876; G06F 3/04815; H04L 67/02

(57) ABSTRACT

A virtual shopping mall contains virtual shop fronts that operate as gateways into virtual rooms containing a graphic user interface (GUI). The GUI supports an online homepage of a vendor previously associated with the virtual shop front. An avatar window in the GUI contains the virtual room and presents discount codes available from the specific vendor. A second window in the GUI presents a vendor's real-time online homepage. A personalised avatar is managed by a marketing affiliate that promotes vendor discount codes. Registration ties the avatar to a unique IP address of a user's computer. Entrance of registered avatars into a specific virtual room via a specific gateway triggers a cookie being sent to the user's computer and automatic opening of the vendor's homepage. Retrieval of the cookie by the vendor's sever correlates the marketing affiliate to the IP address at the user's point of interest at the vendor's website.

### BACKGROUND TO THE INVENTION

This invention relates, in general, to a social network based online shopping environment that is particularly, but not exclusively, applicable to a process of managing discount codes within a virtual shopping mall. Applications of the virtual shopping mall can be extended to an on-line gaming environment to extend on-line shopping to a collective social interaction between multiple remote participants.

### SUMMARY OF THE PRIOR ART

Online shopping through a personal computer (or even a smartphone application) is extremely attractive and has been achieving year-on-year growth for retailers. To promote such commerce, retail outlets frequently provide “discount coupon codes” or “discount voucher codes” to marketing affiliates, with these “discount codes” offering financial discounts or additional benefits or incentives to purchasers who visit the online stores and complete a sales transaction. In many respects, the provision of discount codes is analogous to television advertising, albeit that the discount codes are actively promoted as “pop-ups” or “banner” advertising and therefore accessed and obtained through a website of a specific retailer or via an intermediate internet marketing affiliate who markets the retailer or its product.

One of the issues with respect to discount codes issued via an intermediary marketing affiliate relates to recognition that the marketing affiliate has successfully referred a client to the retailer's website. More specifically, in order to be paid, the marketing affiliate must somehow associate their unique electronic identity (“ID”) with an online store visit that has resulted in a completed transaction. Unfortunately, acquisition of a coupon code is a multistep process that involves multiple parties, so an effective introduction of a client is by no means certain to result in appropriate credit being garnered by the marketing affiliate. To better understand the problem, it is worth considering the coupon allocation process in more detail.

The retailer is seldom directly approached by a marketing affiliate. Instead, the retailer notifies a brokerage (“Affiliate Window”) that it is prepared to provide discount on one or more selected items in its store. The brokerage therefore provides a shop front to marketing affiliates, with the brokerage compiling a database that lists the retailer(s) against current available discount codes and, typically, an associated products review or a weblink to the store. To acquire a discount code, a marketing affiliate concludes a contractual relationship with the brokerage.

In practical terms, the marketing affiliate approaches the brokerage and says: “I have a website that is accessible via the Internet site ABC and I want to promote retailers X, Y and Z on my website and particularly products/services xx, yy and zz offered, respectively, by X Y and Z Please register my own unique electronic ID code so that it can embed it in a cookie and communicated onwards to my customer as a marketing/promotion opportunity”. The unique ID might be the marketing associate's own IP address or some other unique code created by or for the marketing affiliate. On agreed commercial terms, the coupon code (e.g. 123fx567gb) and the unique electronic ID (e.g. “HHH_Cavia”) is provided to or otherwise associated with the marketing affiliate.

The brokerage may, in fact, be the vendor's website, but in essence the brokerage acts as an intermediary that sends out cookies on behalf of the marketing affiliate and, furthermore, establishes initial contact between a consumer PC (having a unique IP address or some other unique addressable code) and the vendor website. The brokerage also is critical in the process of seeing that converted transactions are settled against the referral agency, i.e. the marketing affiliate. After the initial contact for an online sales session is established by the brokerage, control of the resulting point-to-point connection between consumer (i.e. the consumer PC) and the online website (supported on the vendor server) is passed to the vendor server for onward management for the duration of the online session.

From the consumer's perspective, the present regime requires that the consumer initially interact with the marketing affiliate and then the retail website (in the event that the consumer wishes to make use of a discount code). More specifically, using a computer or other addressed device having a unique IP address, the consumer enters the website of the marketing affiliate and identifies the discount opportunity. The operating system on the server at the marketing affiliate is set up not to reveal the discount voucher until the consumer ‘clicks’ on an associated button on a graphic user interface. The action of the click, in effect, seals a contract with and for the marketing affiliate. The marketing affiliate is at this point able to acquire the unique IP address of the consumer's computer, with this address allowing the marketing affiliate to gain referral credit from the brokerage and vendor.

A cookie is sent to the consumer's internet ready device, which cookie includes the unique electronic ID (e.g. “HHH_Cavia”) of the marketing affiliate, the vendor's website address or “url” (e.g. http://amazon.com) and a time and date stamp. The cookie is stored in the consumer's computer. The cookie, although tagged with the unique ID of the marketing affiliate, is delivered to the consumer's PC from the brokerage.

Unfortunately, internet security applications and fire walls can reject cookies, or otherwise operate automatic cleanout of cookies. Both these operations potentially lead to or absolutely result in zero recognition for the marketing affiliate and therefore no (or at least slow) payment in the event that the consumer completes a transaction with the discount code.

At the point that the consumer enters the retailer's website, the stored cookie is retrieved from the consumer's cache memory by an interrogation process executed by the server of the vendor/retailer. [Alternatively, the act of entering the web site may result in the cookie being pushed by the PC to the retailer/vendor server 14]. The server then logs the data in the cookie against the computer's IP address. The retailer is therefore made aware of the point of referral, i.e. the unique ID of the marketing affiliate, the consumer identity (in the form of the unique IP address) and also whether the referral is the most recent in time relative to other cookies for discount code acquired from other third party marketing affiliates for the same product offered by the specific retailer. If a discount code is subsequently used to complete a related transaction during either the consumer visit or a subsequent consumer visit, then the transaction is electronically registered and recorded by the retailer's server and the retailer is obliged subsequently to notify the brokerage (typically in a scheduled data dump, although notification could occur at the point of transaction) about transacted business conducted against the backdrop of related unique IDs of the marketing affiliate(s). In completing the associations, the commercial contract can be completed and agreed marketing payments shared with (at least) the marketing affiliate and possibly the brokerage (if subject to any revenue sharing agreement).

Furthermore, with respect to the revealing of the discount code to the consumer, this is not as straight forward as it would at first sight appear to be since the discount code is presented in a first window that has no direct relationship to the retailer. Consequently, not only is it not apparent whether the cookie has been recovered by the consumer and the discount effectively made available to the consumer, but the discount code must be copied and applied in a separate retailer window at a specific time, e.g. at “checkout” and transaction authorization. Not only is this acquisition process tedious and involving of multiple consumer steps across multiple windows, but the nature of the discount code lends itself to loss or errors in copying especially when one considers that the points of access to and entry of the discount code may not be contiguous in time.

### SUMMARY OF THE INVENTION

According to a first aspect of the invention there is provided a social network based shopping environment presentable across a wide area network, comprising: a vendor server supporting a retail website; a brokerage server including a database storing discount codes relevant to the retail website and unique IDs of marketing affiliates authorised to promote the discount codes, the brokerage configured to send cookies containing the unique IDs; a marketing affiliate system having a unique ID and configured to present a virtual shopping mall realised by a multiplicity of virtual shop fronts that each operate as a gateway providing access into a virtual room, the virtual room containing a graphic user interface related at least in part to a specific vendor; a plurality of computers each having an unique address referenced into the marketing affiliate system, each computer configured: to present the virtual shopping mall on a display; to control movement of an avatar within the virtual shopping mall, the avatar associated with unique address; to receive a cookie from the brokerage; and to gain access to and navigate through the retail website; and wherein control logic associated with the marketing affiliate system causes conveyance of the cookie to a first computer at a point when an active avatar in the virtual shopping mall presented on said first computer passes through a gateway associated with a specific vendor and wherein the control logic furthermore opens the retail website within the graphic user interface of the virtual room substantially at the time when the active avatar arrives in the virtual room.

In a preferred embodiment, the graphic user interface in the virtual room of a vendor further includes an interactive window for receiving a plurality of avatars from different computers, the interactive window independent of a window in which the retail website is displayed.

The interactive window may include a chat box permitting at least one avatar to post a comment.

The interactive window may be selectively populated with discount codes, the discount codes relating to the vendor in whose virtual room the active avatar is located.

In a particular embodiment, the brokerage server is configured to establish a connection between the vendor server and the first computer, whereafter the vendor server is configured to: retrieve the cookie from the first computer to effect seamless point to point connection to the first computer; and correlate activity on the first computer as being promoted by a specific marketing affiliate having its unique ID both stored in the brokerage server and conveyed to the first computer in the cookie.

In another aspect of the invention there is provided a user interface application arranged to generate a virtual shopping mall on a display, the virtual shopping mall including a multiplicity of virtual shop fronts each operating as a gateway to provide access into a virtual room associated with each gateway, the virtual room containing a graphic user interface related at least in part to a specific vendor website that is controlled independently from the virtual shopping mall.

Each gateway acts as a trigger point to cause conveyance of the cookie to a computer on which the user interface application is running.

The virtual room produced by the user interface application is preferably further arranged to display an interactive window that is independent of the specific vendor website.

The virtual room is preferably configured to support interactive communication between at least two independent users.

In another aspect, an online shopping game contains or supports the user interface of claims 8 to 13.

In a further aspect of the present invention there is provided a method of managing presentation of discount codes related to an online retail environment, the method comprising: at a brokerage server, storing (i) discount codes relevant to a retail website and (ii) unique IDs of marketing affiliates authorised to promote the discount codes; on a computer, generating a virtual shopping mall realised by a multiplicity of virtual shop fronts that each operate as a gateway providing access into a virtual room, the virtual room containing a graphic user interface related at least in part to a specific vendor; registering a unique IP address of a computer to an associated avatar controllable moveable within the virtual shopping mall by a user; monitoring movement of the avatar as controlled by the user; and generating and sending a cookie to the unique IP address of the computer when the avatar, under user control, transitions through a particular gateway so as to be presented with the graphic user interface related at least in part to website of the specific vendor and wherein the cookie includes the unique ID of a marketing affiliate.

The method of managing presentation of discount codes may further include, in the virtual room, displaying an interactive window that is independent of the website of the specific vendor. Also, the method may support interactive communication between at least two independent users within the graphic user interface of the virtual room.

Advantageously, the present invention provides for an automatic delivery and registration of a discount code through the ability of a marketing affiliate to place discount codes into a virtual room associated directly with a real-world online retailer, the virtue room accessed via a virtual shop front a virtual shopping mall. Beneficially, as soon as a registered avatar passes through a gateway into the virtual room, the avatar is provided with access to the real world online website. Moreover, the computer to which the avatar is registered receives a cookie that includes the marketing affiliate's unique identity and also time and date stamps to a particular vendor's online website. The cookie therefore is provided seamlessly to the computer and in such a way that the cookie directly links to discount benefits available to the customer within the virtual room.

Indeed, the present invention marries together gaming and marketing activities, but in a fashion that provides a real-world technical effect through an improved cookie generation process that is more robust and ensures a seamless registration of interests. The virtue room provides a multi-access point for remote users to both exchange views and shop without having to open up secondary windows and to toggle between these different windows. This arrangement is more efficient and provides a simplified graphic user interface that is targeted to the particular retail website.

In a preferred embodiment, a virtual shopping mall contains a multiplicity of virtual shop fronts that each operate as a gateway into a virtual room containing a graphic user interface. The GUI supports an area for interactive social communication between registered avatars and, furthermore, an online homepage of a vendor previously associated with the virtual shop front. An avatar window in the GUI contains the virtual room and further presents discount codes available from the specific vendor. A second window in the GUI opens simultaneously with the avatar window and presents a vendor's real-time online homepage. A personalised avatar is generated and registered by system intelligence whose overall control is managed by a marketing affiliate that promotes vendor discount codes. Registration ties the avatar to a unique IP address of a user's computer. The system-wide intelligence is configured to detect the passage of registered avatars into a specific virtual room via a specific gateway, with entrance triggering both automatic sending of a cookie to the user's computer and automatic opening of the vendor's homepage. Retrieval of the cookie by the vendor's sever seamlessly correlates the marketing affiliate to the IP address at the user's point of interest at the vendor's website given that the cookie includes a unique identity associated with the marketing affiliate.

The interface of the present invention therefore provides access to a virtual world in which there is an embedded web-page viewable and controllable from within the virtual world, with the interface supporting access to a social network based shopping environment presentable across a wide area network.

### BRIEF DESCRIPTION OF THE DRAWINGS

Exemplary embodiments of the present invention will now be described with reference to the accompanying drawings in which:

FIG. 1 illustrates functional elements within an internet-based coupon redemption system;

FIG. 2 is a schematic representation of a virtual shopping mall used in a preferred on-line environment;

FIG. 3 illustrates a preferred user interface between a retailer web site and a social networking area of the virtual shopping mall of FIG. 2 and

FIGS. 4 and 4b combine to provide an exemplary flow diagram of a potential registration process that leads to contract settlement with a marketing affiliate promoting discount codes according to an embodiment of a preferred operating methodology.

### DETAILED DESCRIPTION OF A PREFERRED EMBODIMENT

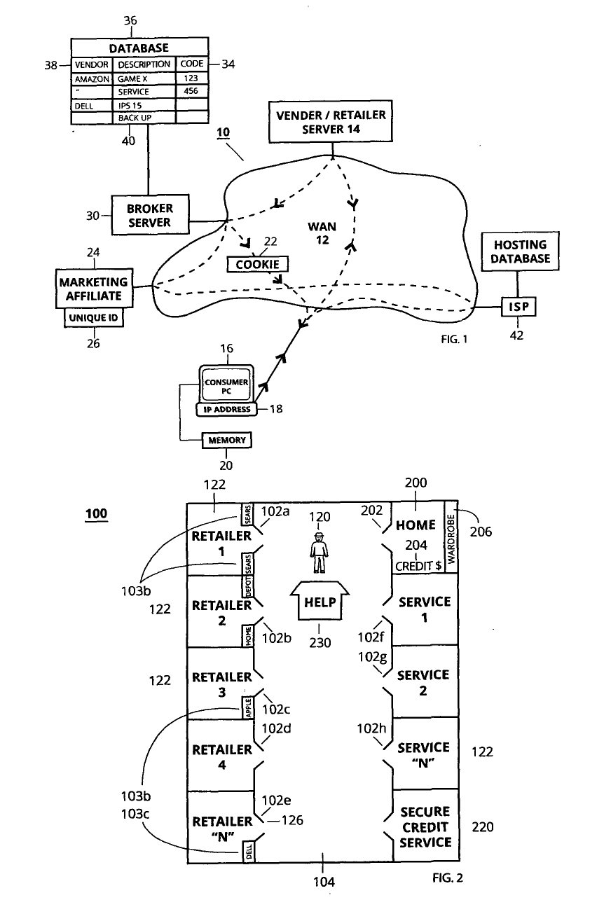

FIG. 1 illustrates functional elements within an internet-based coupon redemption system 10 that may be adapted to support the concepts of the present invention.

Based around access to a wide area network 12 (such as the worldwide web), a vendor/retailer server 14 provides a user interface supporting purchase of retail goods or services through a secure portal. The vendors/retailer server 14 is therefore typically a web server that allows a remote web browser, loaded on a consumer PC (or the like) 16, to interface with and select goods or services for a commercial transaction. The consumer PC has a unique IP address 18. The consumer PC 16 is also connected to the WAN 12 through a modem. The consumer PC 16 includes memory, such as cache 20, for storing cookies 22 issued from a brokerage server 30.

The cookies, which are marketing affiliate specific, are stored in the brokerage server's database 36 and contain the marketing affiliate's unique ID. Each cookie therefore correlates to the marketing affiliate. The cookies are only brought into existence (and stored in the database) if the brokerage: i) accepts that the marketing affiliate satisfies stipulated criteria for promoting discount codes in the representation of the vendor/retailer; and ii) has concluded a commercial agreement with the marketing affiliate. The database 36 of the brokerage server therefore cross-references vendor information 38 against both a product or service description 40 and the corresponding (current) discount code 34 offered by the commercial entity and furthermore relates these parameters to approved marketing affiliates and particular marketing affiliate IDs.

Typically, the system includes an Internet Service Provider (“ISP”) 42 that contracts with the consumer PC 16 to provide internet services to the PC 16.

In operation, the system 10 functions generally as described above and thus provides a cookie for storage in and retrieval from the memory cache 20. The inventors have however recognised that the release of cookies can be better managed and can promote sales opportunities.

A preferred embodiment of the present invention will now be described in the context of an online game environment. However, the present invention has wider application. The game environment simply provides a vehicle for distribution and access to discount codes through a game on a social networking site, such as Facebook or more general game-play platform (like the SIMS). In contrast, the underlying concepts for a virtual shopping mall allows that supports effective access to discount codes and which, additionally, can support interactive social networking between remote users can be presented through any suitable portal, including a web browser.

### 1. Virtual Shopping Mall

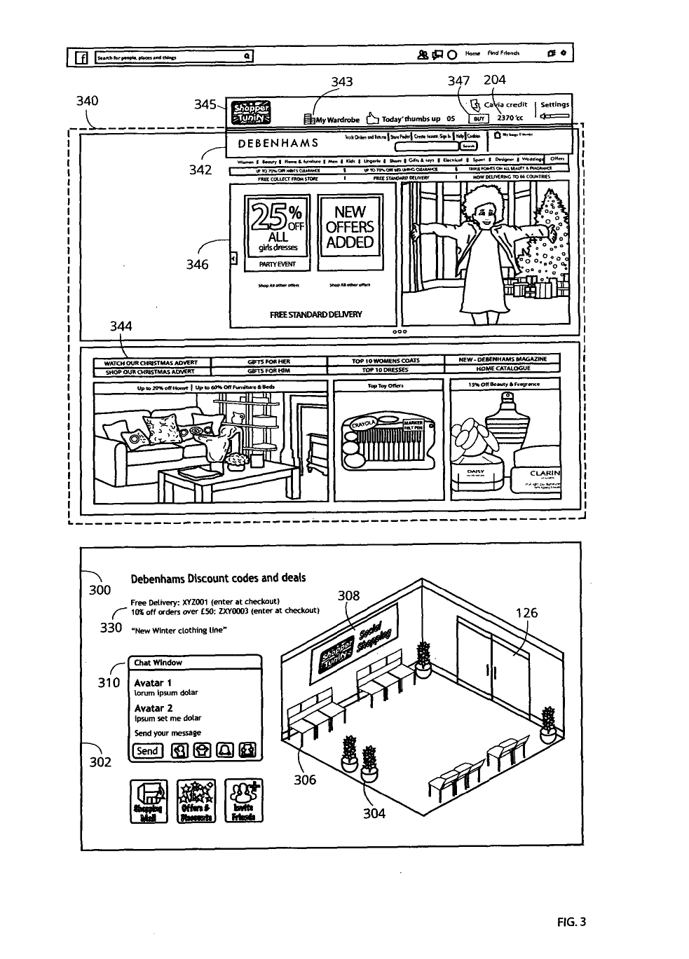

FIG. 2 is a schematic representation of a virtual shopping mall 100 used in a preferred on-line environment. The virtual shopping mall 100 is typically accessible via a processor instantiated web browser, with features within the virtual shopping mall 100 engaged through interaction with a personalised avatar that can be controlled and directed through the shopping mall by a user interface in the web browser. The virtual shopping mall can be depicted as either a 2-D plan or a 3-D virtual environment, with it preferably being a 3-D environment that may include multiple levels.

The virtual shopping mall 100 essentially comprises a multiplicity of compartmentalised virtual shop fronts 102a-102h that act as facades within the virtual shopping mall 100 for real retail entities, such as department stores, fashion retailers, pharmacies and support services (such as hairdressers and taxi companies). Typically, the virtual shop fronts therefore each present a banner 103a-c that is viewable from a concourse region 104 of the shopping mall 100, with the banner usually taking on the “get up” or trade dress of the store that it represents. For example, the shop front may include typical advertising hoardings and store front architecture used conventionally by the retailer on the high street, e.g. a Sears® or Home Depot logo or a logo for Marks & Spencer . The front fronts may include both retailers and service providers. In many respects, the layout and navigation through the virtual shopping mall 100 is not unlike Google® Maps, albeit that the compartmentalised virtual shop fronts are configurable based on programming by the marketing affiliate.

The use of an avatar 120 is preferred since it provides a degree of personalization to the virtual environment and permits recognition in a social networking environment (to be described later), although the avatar could simply be an on-screen computer-generated pointer. Navigation through the shopping mall 100 is therefore controlled by movement of the avatar 120, with the avatar able to interact with a shop front to allow entry into a virtual room 122 that is behind each shop front. For example, a representation of a door, portal or opening 126 (collectively referred to as a “gateway”) may allow access of the avatar to the virtual room 122.

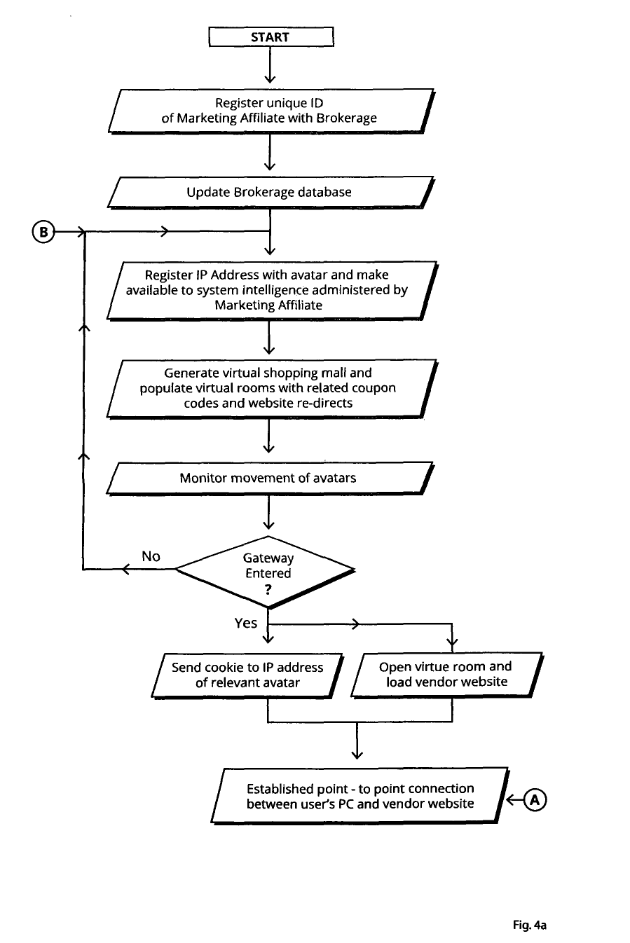

The effect of an avatar passing through the gateway 126 will be described subsequently in relation to FIG. 3, although it is briefly noted that, importantly and inventively, once the avatar is through the door or opening 126, the avatar enters the virtual room 122 that allows both social networking with third-party avatars and, moreover, the ability to directly access the real homepage (through the URL address) of the retailer corresponding to the virtual shop front. The door 126 therefore represents a gateway between an entirely virtual environment and a real-world interface. In addition, an aspect of the virtual room 122 automatically displays available real-time discount codes relevant to the actual products and services offered by the retailer, with the act of entry meaning that the IP address associated with the avatar is sent one or more cookies for currently available offers for that particular retailer. The discount codes, presented in the virtual room, are populated by the marketing associate (and not usually by the vendor/retailer) and therefore appear within the confines of the virtual room rather than the real world retailer website. The displayed discount codes are selectable within the context of the virtual room 122 for immediate use in the real environment of the online store, but importantly the discount codes are present on a common screen that is split between the online store (and point of sale) and a virtual chat room. No independent request for release of the discount code is made by the user. Rather, the entry into the virtual room behind the virtual shop front acts as the trigger point for the generation and transmission of the cookie to the avatar's associated real-world IP address. The avatar's presence in the room is merely acceptance of a contractual term (imposed, for example, by signing up to the game) by the player/consumer to receive promotional cookies for the associated store and on an automatic basis.

In more detail, system intelligence detects the transition of the personal avatar through the gateway 126 into the virtual room 122. The system intelligence is under the control of the marketing affiliate's operating platform, which is generally server-based but may include multiple inter-operative processors in a distributed configuration, as will be understood. The system intelligence (and particularly logic controllers that manage the execution of software and the interaction between features) of the virtual shopping mall 100 then instructs the brokerage to release a cookie and simultaneously to open up the external website supported on the vendor/retailer server 14. The vendor/retailer server 14 can then take over point-to-point connection with the consumer PC 16 and retrieve the contents in the cookie, with the brokerage effectively able to step back from the subsequent commercial traffic and handshaking between the vendor/retailer server 14 and the consumer PC 16. Since the cookie includes the unique ID of the marketing affiliate, a time and date stamp and the website identity of the vendor, the vendor/retailer server 14 can provide register the referral and conclude a reward to the marketing affiliate in the event that a sale is transacted, especially if the sale makes use of a discount code.

Digressing slightly from the principle concepts of (1) making discount coupons automatically available within a virtual room associated with a real-world web store and (2) supporting an interactive social network chat room that permits multiple personalised avatars to express real world user opinions of the offers, products or indeed the retailer, it is observed that social networking activity is geared around posting comments to friends that are supposed to entice a response, such as a “like”.

### 2. Game Play & Virtual Credit

Many games have been developed that require online cooperation and actually seek online interaction. The inventors have also realised that to promote uptake of a real-world shopping activity, one mechanism involves the presentation of, and participation in, an online shopping game. In this respect, the virtual shopping mall 100 can be provided as an online game on a social networking website, such as Facebook, in which a player is initially provided with a generic avatar and a nominal and initially limited amount of virtual credit which can be used to customise the avatar's appearance.

More particularly, in order to create a personalised avatar and thus a game account, a game player (i.e. a potential real life shopper) initially logs into the game program (supported by the marketing affiliate 24) and registers (with the marketing affiliate) their unique username which is generally associated with a specific and unique IP address or email account that can be used for tracking purposes. In this respect, the game may be offered on the server 42 of the ISP rather than a bespoke server and accessed, for example, via an existing well-known social networking website. To run the game (or indeed the virtual shopping aspect), the consumer's PC 16 need only contain a web browser, although locally stored code is an alternative.

Once registered, the user's avatar is loadable into the concourse region 104 to explore the virtual shopping mall 100; loading can be to a default point or to point of a previously saved in a quest. The system intelligence is therefore architecturally arranged and functionally configured (through software code and access to databases) to store avatar data, including the associated IP address, virtual shop fronts and related online website addresses for retailer/service provider homepages and game completion statistics. Of course, the marketing affiliate has full control of the virtual shopping mall and therefore provides updates and additional layers of detail by entering data into the database to affect a change in the presentation of the virtual shopping mall, for example.

To provide a degree of customisation and to spend the initial virtual credit, the virtual shopping mall 100 includes a homeroom 200 which is accessible either through a door or opening 202, or otherwise via an icon 343 on a user interface header or a link (reference numeral 343 of FIG. 3) in user interface header 345. Upon entering the homeroom 200, the user is presented with a running total 204 of virtual credit and a wardrobe 206 of selectable avatar features, such as hats, clothing, jewellery and personality traits or personal features, such as eye colour, etc. Alternatively, virtue credit can be continuous viewed in the user interface header 345. Whilst some of these avatar features may be free, others may be purchased using the available virtual credit. The system is configured such that changes to the avatar are recorded for use within the game and both the shopping and social networking experiences provided herein.

After exiting the homeroom 200 or otherwise by clicking on a map icon to effect a teleportation of the avatar to a selected location in the virtual shopping mall, the personalised avatar is able to roam freely throughout the virtual shopping mall 100, although interaction with other third party avatars may be restricted to locations to provide a degree of social protection and potentially restrict networking to an approved group of player/shoppers.

Ideally, virtual credit can actually be acquired during gameplay through the completion of tasks and especially virtual shopping-related tasks, e.g. “find the latest (real world) Sears discount coupon for designer dresses in the Summer Sale”, but otherwise virtual credit can be purchased from a secure credit service supporting a secure financial transaction. Preferably, the secure credit service is accessed through a corresponding credit service room 220 within the virtual shopping mall 100, or otherwise via a “buy now” icon 347 in the user interface header 345. The ability to purchase additional virtual credit from a server run by a hosting company is an option, but provides a mechanism to retain the attention of a player whilst continuously exposing the player to commercial transaction opportunities that are provided seamlessly and discounted relative to conventional direct access to online retailers and service providers.

In terms of acquiring credit through tasks, the game is preferably configured such that the avatar is given objectives to achieve within the shopping mall, such as: i) visiting particular virtual rooms 122 behind virtual shop fronts; ii) locating and talking to game-advising avatars who are planted within the game by the marketing affiliate and who are planted to relay or otherwise provide information about particular advertising campaigns for particular real life stores having virtual shop front representation within the virtual shopping mall 100; and iii) acquiring trophies or virtual items stored or re-stocked over time by a game administrator, i.e. the marketing affiliate, in those rooms.

Some in-game assistance is preferably always provided through some form of prompt or help, such as available at an interactive help desk 230 in the concourse 104 or through a help icon in the user interface header 345. The specific location of the help desk 230 is down to design choice. Again, prompts are controlled and updated by the marketing affiliate uploading or changing information in the hosting computer's online database (such as might be connected to the ISP server 42 and accessible by the marketing affiliate 24 of FIG. 1).

By acquiring credit, e.g. during exploration of the virtual shopping mall 100, further customisation of the avatar is possible by returning to the homeroom 200 and either uploading collected items or trophies into the wardrobe 206 or purchasing items that exist in the wardrobe 206. It is contemplated that changes to the personal avatar can, in fact, be updated anywhere within virtual shopping mall 100.

The benefit of presenting the virtual shopping environment in the context of a game is that there is no direct sales pitch, but rather a suggestion and an ease of access to a multiplicity of real-world online stores that are accessed through a single interface, i.e. the virtual shopping mall. The software of the invention encourages window shopping, but with social interaction. There is therefore a reduced need for a consumer to surf the net for a particular form of retail or service support outlet, with the system configured to allow a player/consumer to log on and essentially explore a well-known commercial high street. The game aspects are however subordinate to the technical aspects that relate to the effective registration of discount codes and the provision of discount codes in a related computer window, rather than across multiple windows and multiple websites.

### 3. Virtual Rooms and Social Networking

As will now be understood, the computer program that supports the present invention generates a virtual shopping mall 100 containing a multiplicity of virtual shop fronts 102a-102h that provide access to an associated virtual room 122. Once the avatar has passed through a virtual shop front, the system's intelligence (which may be distributed, but is typically located in one or more processors located at the hosting site controlled by the marketing affiliate) recognizes transit through the gateway 126 and, preferably, provides two options: a private virtual room or a public virtual room.

The difference between a private virtual room and a public virtual room relates to whether the specific avatar of the player/consumer is able to host entry of third party avatars and, typically, whether these third party avatars are known associates or friends invited into a private room or otherwise the general public who are simply permitted access to the public virtual room (subject to there being space). The system intelligence therefore keeps track of whether the player/consumer has selected a private or public room and correspondingly admits avatars from the concourse region 104, as appropriate. Of course, it will be appreciated that the system intelligence supports the simultaneous opening of multiple occurrences of the virtual room associated with each real-world online store; this is just a database management issue and on-line tracking of active personal avatars.

Reference is made now to FIG. 3 to explain the graphic user interface (GUI) 300 presented at point of entry to the virtual room 122. Based, for example, on a web browser technology, the GUI comprises two discrete regions or windows: an avatar window 302 shows the virtual room 122 that has seating to accommodate up to a fixed number of avatars, e.g. ten in total representing ten individuals, and a second window that opens simultaneously with the avatar window and in which second window there is loaded the vendor's online website. The avatar window includes the user interface header 345 since this header relates to aspects of the game. The physical position of the user interface header 345 is not important. An embodiment makes it possible to “post” a comment in the chat box 310 or to message to post to a friend. In terms of direct interactions, these may also be brought about by the presence of a second third party avatar in the virtual room. For reasons of clarity only, FIG. 3 shows no avatars in the virtual room and thus is merely indicative of the general set up of an exemplary GUI. Of course, the precise layout of the GUI (and particularly the avatar window) is down to design choice.

The virtual room may include aesthetic considerations, such as ornaments 304, furniture 306 and pictures or advertising 308 relevant to the virtual room and its associated online store. Indeed, from the perspective of a private room, this can be furnished and modified through purchases of virtual items from virtual credit redeemed in the homeroom (reference 200 of FIG. 2).

The avatar window 302 further includes a “chat” box 310 that permits instant messaging to be communicated to remote computers of avatar “friends” who are known to and trusted by the player/consumer and who are either present within the virtual room 122 or otherwise generally online. The chat box 310 can therefore be used to post thoughts and develop social interaction with other avatars whether known (and thus invited) or who are just part of the general community of avatars registered within the system and who simply enter a corresponding public room in their own virtual shopping mall. In this way, the avatar window 302 supports conversations without having to open any additional communication platform, such as Skype® or email. The chat box 310 provides a platform for social discussion directly relevant to the real-time purchasing experiences or purchasing opportunity being presented is to the player/consumer.

The avatar window 302 also includes a listing of available discount codes 334 the online store associated with the virtual room 122. These can be selected directly and are preferably directly ported into the online retailer website, although the discount codes may need to be copied at an appropriate time from the avatar window into an appropriate coupon redemption point in the retailer website.

A second window 340 in the virtual room preferably opens up within a hole or frame of the avatar window 302, e.g. between the user interface header 345 and a lower section of the avatar window that displays the virtual room and chat box 310. The second window 340 permits, initially, the insertion of the related retailer home page 342 for online sales and ultimately allows for full site navigation through the retailers website to support browsing and purchase of goods or services. In this respect, the second window may include drop-down windows 344 and advertising banners 346 that support navigation through the store and which are available through conventional direct access to the online store through the internet.

The combination of the second window 340 with the avatar window 302 allows for direct and potentially time relevant entry of product discussion and commentary on discount codes and, indeed, likes and dislikes of the online store and/or product. The GUI 300 therefore assimilates a virtual environment containing avatars into a personal shopping experience involving third parties who are able to comment on what is preferably being viewed within the users own incarnation of the virtual room for a specific retailer at a specific time. Moreover, discount codes which are presented in the avatar window 302 have direct relevance to the website of the retailer associated with the virtual room 122.

The second window preferably therefore allows sharing of a view in a particular virtual room, with navigation through the online store controlled only by the room owner or first occupant. In this way, the chat box 310 is led by the controlling avatar in that the chat may well be related to what is being viewed, the e.g. “What do you think of this colour sofa and is it too big for the lounge? What are your thoughts on me buying this sofa knowing that my husband doesn't want to reposition the cinema surround system and TV. Which colour sofa and material do you prefer?”. To support interactive navigation through a website, it is envisaged that to avatars within a room share a token that can be passed between the avatars, with this token representing control the website.

In overview, links displayed in the concourse region 104 are selected by the controlling game server and are based on store access and availability from a particular real-world vendor or service provider. The game server may, in fact, simply be a server providing the virtual shopping mall to a universe of users, with the content controlled by the marketing affiliate with a view to exploiting relationships with brokerages and vendor/retailers (as described in the context of discount codes). The links are automatically made available in the virtual shopping mall and particularly at the GUI accessed in the virtual room 122.

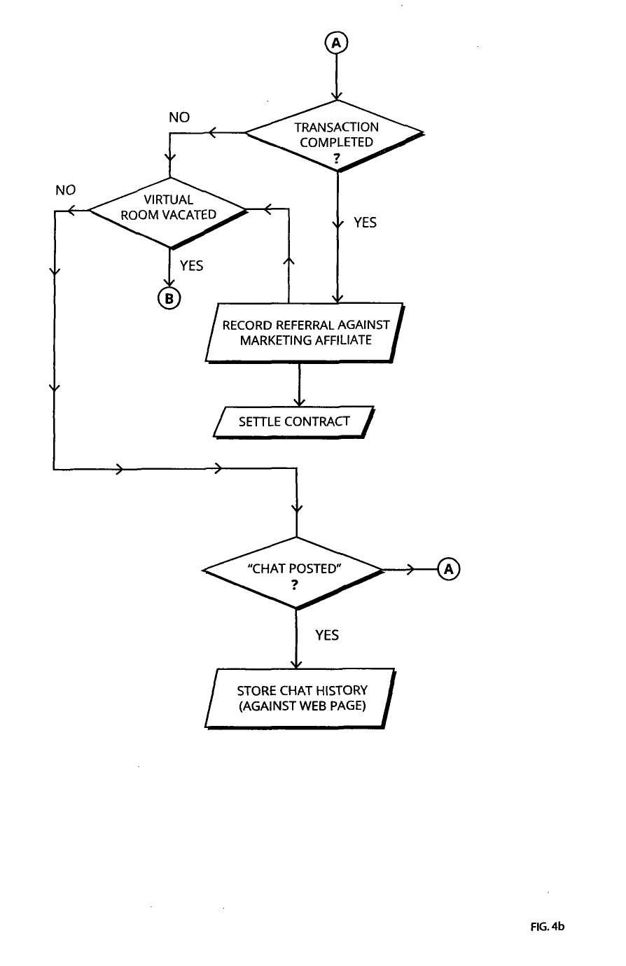

With brief regard to the flow diagram of FIG. 4, the process is generally outlined. From the foregoing it will therefore now be appreciated that, upon visiting the virtual room, the user's IP address (associated and stored against the avatar) is tracked by the system intelligence. Since the virtual room is built up by the marketing affiliate (reference 24 of FIG. 1) having a unique ID (as explained above) and the system intelligence is aware of the affiliation between the virtual room 122 and the real world retailer with whom the shop front 102a-102h is associated, the system intelligence is configured to operate to send a cookie (reference numeral 22 of FIG. 1) to the player/consumer's PC 16 for storage and subsequent use. Given that the second window 340 is a portal to the online store of the retailer, any positive action by the consumer to enter or use the online store whilst in the virtual room means that the online store retrieves the stored cookie and the marketing affiliate is immediately credited with delivering a customer to the online store. Moreover, since current discount codes 330 are presented in the avatar window 302, the player/consumer is able to copy and/or drag-and-drop the discount code into a checkout window supported by the website and presented at the point of including a sale. In this way, the system intelligence associates the use of the discount code 330 with the virtual room and thus with the marketing affiliate, thereby permitting the marketing affiliate to receive payment from the vendor/retailer. Any posted chat arising entered or otherwise posted against a relevant page may be stored for historical reasons and made available to the specific avatar, its “friends” or the public in general (based on rules applied by the system intelligence and set by the marketing affiliate).

It will be understood that the specific steps in FIG. 4 may, in fact, occur in a modified order unless they are critical to establishing the virtue room or the various registration processes that pre-empt the use of the avatar within the environment within the virtual shopping mall 100. The specific methodology in FIG. 4 is therefore only exemplary of one possible embodiment.

Unless specific arrangements are mutually exclusive with one another, the various embodiments described herein can be combined to enhance system functionality and/or to produce complementary functions that improve resolution of, for example, estimations of distance or position. Such combinations will be readily appreciated by the skilled addressee given the totality of the foregoing description. Likewise, aspects of the preferred embodiments may be implemented in standalone arrangements where more limited functional arrangements are appropriate. Indeed, it will be understood that unless features in the particular preferred embodiments are expressly identified as incompatible with one another or the surrounding context implies that they are mutually exclusive and not readily combinable in a complementary and/or supportive sense, the totality of this disclosure contemplates and envisions that specific features of those complementary embodiments can be selectively combined to provide one or more comprehensive, but slightly different, technical solutions.

The present invention may be provided in a downloadable form or otherwise on a computer readable medium, such as a CD ROM, that contains program code embedded into a game. A preferred embodiment has the code provided through a social networking site, with access therefore obtained via a server. From a functional perspective, the various virtue rooms and shop fronts need only support the automatic issuance of the cookie and, preferably, the automatic generation of the vendor web-site in the GUI. The appearance of the shop fronts and rooms can, in contrast, take any appropriate form, but it is preferred that they replicate the appearance of the vendor's associated brands.

It will further be understood that the point of providing man acknowledged referral may, in fact, occur without the completion of a discount code-based transaction. For example, the present invention may be employed in online tracking of activity within the internet, with the point of entering the vendor's website sufficient to trigger a recordable event. The term “completed transaction” or its equivalent should therefore be treated with appropriate deference and latitude, unless the specific context requires a narrow interpretation. The term IP address should also be viewed with some breadth and to include any equivalent address that is unique and addressable and which therefore provides a means of tracking a user to a specific device, including a tablet or smartphone.

It is also noted that the term “retail” should be understood to relate to the offer of any good or service irrespective of whether the final transaction is retail to an end user or wholesale to an intermediary who will incorporate the acquired goods or service into another product offering.

It will, of course, be appreciated that the above description has been given by way of example only and that modifications in detail may be made within the scope of the present invention. For example, in the context of the preferred embodiment, reference is made to a virtual shopping mall 100, but it will be understood that one could equally stage the event in the context of a high street. Consequently, the term “shopping mall” should be understood to represent virtual representation of a real world commercial setting.

1. A social network based shopping environment presentable across a wide area network, comprising:
a vendor server supporting a retail website;
a brokerage server including a database storing discount codes relevant to the retail website and unique IDs of marketing affiliates authorised to promote the discount codes, the brokerage configured to send cookies containing the unique IDs;
a marketing affiliate system having a unique ID and configured to present a virtual shopping mall realised by a multiplicity of virtual shop fronts that each operate as a gateway providing access into a virtual room, the virtual room containing a graphic user interface related at least in part to a specific vendor;
a plurality of computers each having an unique address referenced into the marketing affiliate system, each computer configured:
to present the virtual shopping mall on a display;
to control movement of an avatar within the virtual shopping mall, the avatar associated with unique address;
to receive a cookie from the brokerage; and
to gain access to and navigate through the retail website; and
wherein control logic associated with the marketing affiliate system causes conveyance of the cookie to a first computer at a point when an active avatar in the virtual shopping mall presented on said first computer passes through a gateway associated with a specific vendor and wherein the control logic furthermore opens the retail website within the graphic user interface of the virtual room substantially at the time when the active avatar arrives in the virtual room.

2. The social network based shopping environment as claimed in claim 1, wherein the graphic user interface in the virtual room of a vendor further includes an interactive window for receiving a plurality of avatars from different computers, the interactive window independent of a window in which the retail website is displayed.

3. The social network based shopping environment as claimed in claim 2, wherein the interactive window includes a chat box permitting at least one avatar to post a comment.

4. The social network based shopping environment as claimed in claim 2, wherein the interactive window is selectively populated with discount codes, the discount codes relating to the vendor in whose virtual room the active avatar is located.

5. The social network based shopping environment as claimed in claim 4, wherein the brokerage server is configured to establish a connection between the vendor server and the first computer, whereafter the vendor server is configured to:
retrieve the cookie from the first computer to effect seamless point to point connection to the first computer; and
correlate activity on the first computer as being promoted by a specific marketing affiliate having its unique ID both stored in the brokerage server and conveyed to the first computer in the cookie.

6. The social network based shopping environment as claimed in claim 1, wherein the cookie includes a date stamp and a time stamp.

7. The social network based shopping environment as claimed in claim 1, wherein the virtual shop fronts are modelled on real-world shop fronts of different vendors.

8. A user interface application arranged to generate a virtual shopping mall on a display, the virtual shopping mall including a multiplicity of virtual shop fronts each operating as a gateway to provide access into a virtual room associated with each gateway, the virtual room containing a graphic user interface related at least in part to a specific vendor website that is controlled independently from the virtual shopping mall.

9. The user interface application according to claim 8, wherein each gateway acts as a trigger point to cause conveyance of the cookie to a computer on which the user interface application is running.

10. The user interface application according to claim 8, wherein the virtual room produced by the user interface application is further arranged to display an interactive window that is independent of the specific vendor website.

11. The user interface application according to claim 8, wherein the virtual room is configured to support interactive communication between at least two independent users.

12. The user interface application according to claim 8, wherein the virtual room is selectively populated with discount codes related to the specific vendor website.

13. The user interface application according to claim 8, wherein the user interface application is coded into a computer readable medium.

14. An online shopping game containing the user interface of claim 8.

15. A method of managing presentation of discount codes related to an online retail environment, the method comprising:
at a brokerage server, storing (i) discount codes relevant to a retail website and (ii) unique IDs of marketing affiliates authorised to promote the discount codes;
on a computer, generating a virtual shopping mall realised by a multiplicity of virtual shop fronts that each operate as a gateway providing access into a virtual room, the virtual room containing a graphic user interface related at least in part to a specific vendor;
registering a unique IP address of a computer to an associated avatar controllable moveable within the virtual shopping mall by a user;
monitoring movement of the avatar as controlled by the user; and
generating and sending a cookie to the unique IP address of the computer when the avatar, under user control, transitions through a particular gateway so as to be presented with the graphic user interface related at least in part to website of the specific vendor and wherein the cookie includes the unique ID of a marketing affiliate.

16. The method of managing presentation of discount codes according to claim 15, further comprising:
in the virtual room, displaying an interactive window that is independent of the website of the specific vendor.

17. The method of managing presentation of discount codes according to claim 15, further comprising:
supporting interactive communication between at least two independent users within the graphic user interface of the virtual room.

18. The method of managing presentation of discount codes according to claim 16, further comprising:
selectively populating the interactive window with discount codes related to the website of the specific vendor.

19. (canceled)
